(19) United States
(12) Patent Application Publication
(10) Pub. No.: US 2007/0094342 A1
(43) Pub. Date: Apr. 26, 2007

(54) Detachable control window for instant messaging chats

(76) Inventors: James E. Bostick, Cedar Park, TX (US); Randolph M. Forlenza, Austin, TX (US); John P. Kaemmerer, Pflugerville, TX (US); Raghuraman Kalyanaraman, Austin, TX (US)

Correspondence Address: IBM CORPORATION (RUS);c/o Rudolf O Siegesmund Gordon & Rees, LLp, 2100 Ross Avenue, Suite 2600, DALLAS, TX, 75201, US

(21) Appl. No.: 11/257,452

(22) Filed: Oct. 24, 2005

(51) Int. Cl. G06F 15/16

(52) U.S. Cl. 709/207

(57) ABSTRACT

The invention comprises a system for managing chat windows in an instant messaging program in a computer having a graphical user interface, including a display and a selection device, the method comprising receiving an input signal from the selection device indicating the selection and movement of a minimized chat window in a task bar; and responsive to receiving the input signal, detaching the minimized chat window from the task bar and moving the minimized chat window to a position on the display indicated by the input signal.

### FIELD OF THE INVENTION

The present invention is related generally to demand-based messaging systems, and in particular to graphical user interfaces for controlling chat sessions in an instant messaging application.

### BACKGROUND OF THE INVENTION

Demand-based messaging is a communication service that allows people to exchange message data, such as text, over a network or other communications media, in real time. Probably the most common medium for exchange is the Internet, but as wireless phone networks continue to expand, their popularity for text messaging is also expanding. U.S. Pat. No. 6,301,609 issued to Aravamudun et al., and U.S. Pat. Publications Nos. 2002/0035605 and 2004/0254998, for example, illustrate the move toward an exchange medium that unifies traditional and wireless communications. Instant messaging (IM) is perhaps the most widely known and used embodiment of demand-based messaging. Today, most network and online service providers offer some form of IM service. According to some estimates, the top three instant messaging service providers serve over forty million users. Instant messaging services also are being rapidly deployed and integrated into enterprise infrastructure. International Business Machines, Inc. (IBM), for example, has deployed LOTUS SAMETIME instant messaging applications for employees world-wide. Other examples of IM applications that are popular today include MSN Messenger and Yahoo/AOL Instant Messenger.

IM users typically use a networked computer and an IM client program to exchange messages with one another in conversational style. An IM client provides an interface for users to compose, send, receive, and read messages. In a graphical display, an IM client usually includes at least two windows: a window for composing and sending messages, and a window for displaying messages as users take turns sending and receiving them. IM sessions (colloquially referred to as “chats”) are often lengthy, with multiple participants each taking many turns “speaking” in the chat window. It is common for one user to have multiple IM chats running simultaneously, usually in separate windows.

In many of today's graphical operating systems, including the MICROSOFT WINDOWS family of operating systems, windows can be “minimized” as needed to organize the information on a given display. As that term is used popularly, a window is “minimized” when it is reduced to an icon so that it uses only a small portion of the display. Typically, icons representing minimized windows are grouped together and placed along the edge of a screen in a graphical element commonly referred to as a “task bar.” Of course, not much information about a window is visible when the window is minimized. When a chat window is minimized, for example, a user will generally see only a short title and, perhaps, a sender's name. FIG. 1 illustrates an exemplary graphical display 100 with icon 105, task bar 110, command button 115, minimized application windows 120-125, minimized chat window 130, and minimized chat window 135. Note that in FIG. 1, minimized chat windows 130 and 135 display the sender's names (“Al” and “Bill”, respectively).

As the number of windows in a graphical display increases, the operating system typically decreases the size of icons in the task bar and the length of the text displayed in each icon. Thus, as FIG. 2 illustrates, even a sender's name may not be completely visible in a minimized chat window and it becomes difficult for a user to determine the nature of the chat without constantly restoring the chat window to its full size. In FIG. 2, minimized application window 140 has been added to task bar 110, and minimized chat windows 130 and 135 have been compressed to make room for the new icon. Note that the sender's name is no longer visible in minimized chat window 135.

Moreover, the operating system may compress all chat windows into a single icon in the task bar if there are too many icons to display at once. If all chat windows are so compressed, all identifying attributes of the various chats are lost to the user. FIG. 3 illustrates this scenario, in which minimized application window 145 has been added to task bar 110. Because there is no longer room to display all minimized windows in the task bar, the operating system has compressed minimized chat windows 130 and 135 into a single, new minimized group window 150. As FIG. 3 illustrates, minimized group window 150 does not display any chat-specific information.

Thus, existing messaging applications that rely on an operating system to manage chat windows are too cumbersome for effectively organizing multiple chat windows, and there remains a need to advance the state of the art of demand-based messaging to overcome these shortcomings.

### SUMMARY OF THE INVENTION

The invention described in detail below comprises a system for managing chat windows in an instant messaging program in a computer having a graphical user interface, including a display and a selection device, the method comprising receiving an input signal from the selection device indicating the selection and movement of a minimized chat window in a task bar; and responsive to receiving the input signal, detaching the minimized chat window from the task bar and moving the minimized chat window to a position on the display indicated by the input signal.

In an additional embodiment, the inventive system further comprises receiving a second input signal from the selection device indicating the selection of the detached minimized chat window; and responsive to receiving the second input signal, displaying on the display a pop-up list of chat windows.

In another additional embodiment, the inventive system further comprises receiving a third input signal from the selection device indicating a pointer is positioned over the pop-up list of the chat windows; and responsive to receiving the third input signal, determining which chat window in the list the pointer is positioned over and displaying descriptive data about the chat window that the pointer is positioned over.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 illustrates an exemplary prior art graphical display having two minimized chat windows;

FIG. 2 illustrates an exemplary prior art graphical display having two compressed minimized chat windows;

FIG. 3 illustrates an exemplary prior art graphical display having a minimized group window of chats;

FIG. 4 illustrates an exemplary network of hardware devices in which the present invention can be practiced;

FIG. 5 is a schematic of a memory having components of the present invention stored therein;

FIG. 6A illustrates an exemplary control window detached from the operating system task bar;

FIG. 6B illustrates an exemplary minimized control window detached from the operating system task bar;

FIG. 7A illustrates an exemplary compressed control window; and

FIG. 7B illustrates an exemplary compressed control window with a pop-up list of chats.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “chat window manager” program.

Additionally, the chat window manager program is described below with reference to an exemplary network of hardware devices, as depicted in FIG. 4. A “network”comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 400 has only a limited number of nodes, including workstation computer 405, workstation computer 410, server computer 415, and persistent storage 420. Network connection 425 comprises all hardware, software, and communications media necessary to enable communication between network nodes 405-420. Unless otherwise indicated in context below, all network nodes use publicly available protocols or messaging services to communicate with each other through network connection 425.

Chat window manager 500 typically is stored in a memory, represented schematically as memory 520 in FIG. 5. The term “memory,” as used herein, includes without limitation any volatile or persistent medium, such as an electrical circuit, magnetic disk, or optical disk, in which a computer can store data or software for any duration. A single memory may encompass and be distributed across a plurality of media and network nodes. Thus, FIG. 5 is included merely as a descriptive expedient and does not necessarily reflect any particular physical embodiment of memory 520. As depicted in FIG. 5, though, memory 520 may include additional data and programs. Of particular importance to chat window manager 500, memory 520 may include instant messaging (IM) program 530 and configuration data 540, with which chat window manager 500 interacts. IM program 530 represents any demand-based messaging software that provides an interface through which a user can access a messaging service and exchange messages with other users. Configuration data 540 represents any data source (including without limitation a file, table, or database) that identifies one or more of a user's preferences for displaying chat windows. In practice, chat window manager 500 may be integrated with IM program 530, but also may exist independently as an add-on module.

In a preferred embodiment, chat window manager 500 also includes a graphical user interface (GUI), through which a user can interact with and control the program. The design and operation of a GUI is well-known in the art and need not be described in detail herein, but in general a GUI typically includes a display and a selection device. Common selection devices include mice, trackballs, touch pads, touch screens, and the like. An operating system or other program having a GUI draws graphical elements on the display. The graphical elements generally include windows, command buttons, and text boxes. A pointer or cursor also is usually drawn on the display to indicate the position of the selection device with respect to the display. To control a computer through a GUI, a user typically moves the selection device until the pointer is in a desired position, and then presses a button on the device (or simply touches the pad or screen). The device then sends a signal to the processor, indicating the position of the pointer and the user's action (i.e. which button the user pressed and how many times). The processor then responds to the signal according to the computer program associated with pointer position.

Chat window manager 500 organizes chat windows independent of the operating system's control. In particular, chat window manager 500 manages chat windows independent of a system's task bar. Chat window manager 500 may place a chat window in a system's task bar to present the user with a conventional view, but chat window manager 500 also gives the user additional options for configuring the display. These options, and the significant advantages that they offer, are described in more detail below.

Chat window manager 500 includes several user interface features for controlling the behavior of chat windows, including a control window. In one embodiment, the control window is an independent IM task bar control that can be detached from an operating system's task bar. Alternatively, the control window may be integrated into an existing icon in the operating system task bar. The control window allows a user to customize the behavior of chat window, detach the control window from a taskbar, resize the control window, and select display attributes such as font, text size, and color. The user can also configure the control window to always stay on top of other windows on the display. Generally, the user may specify such preferences for appearance and behavior dynamically as chat window manager 500 executes, or may specify such preferences in configuration data 540.

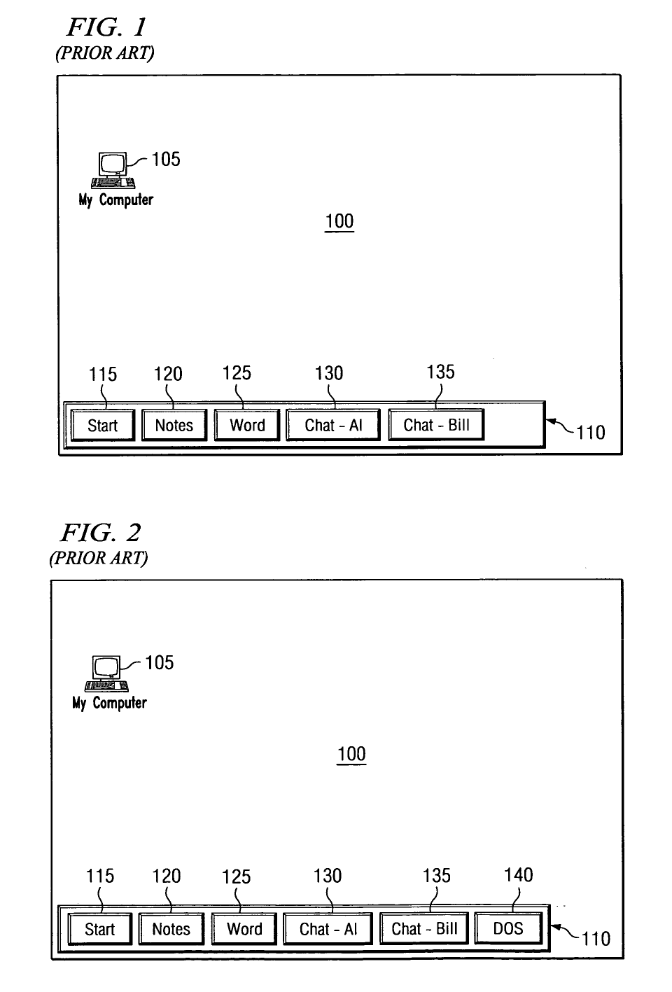

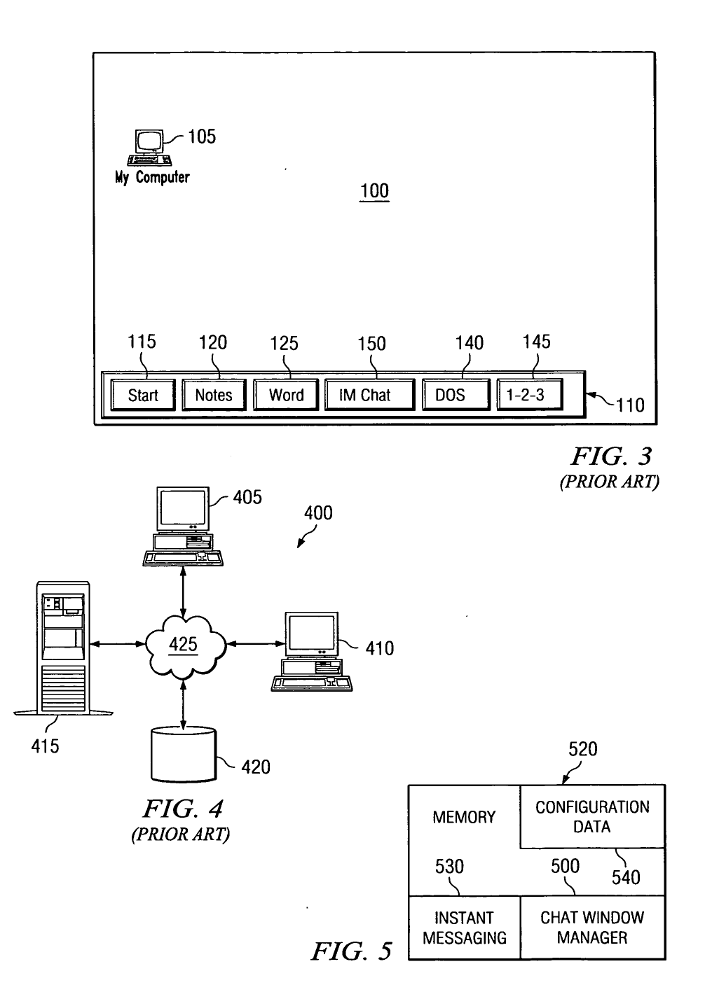

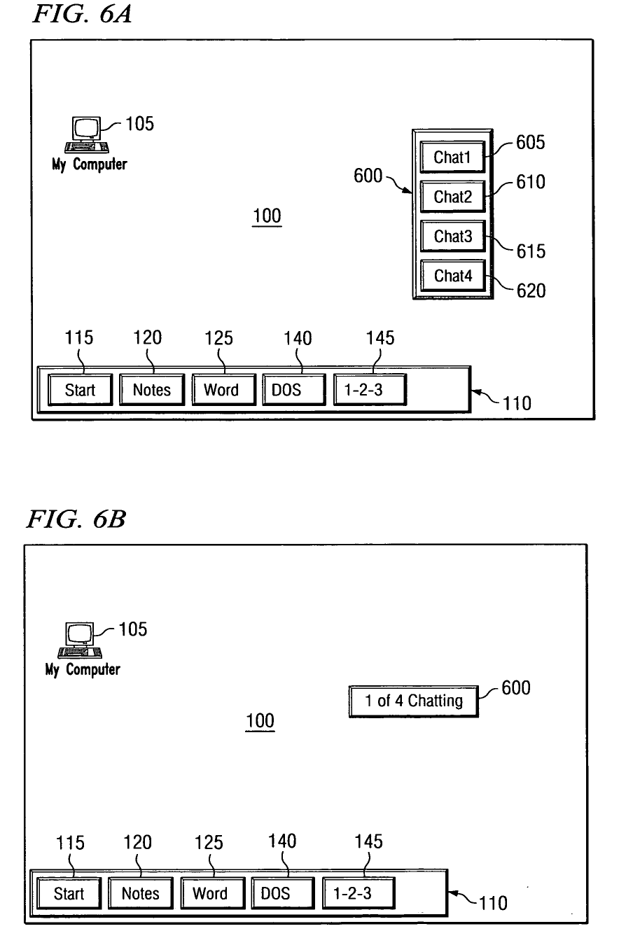

Once detached, the control window may be moved to any part of the user's display. FIG. 6A illustrates exemplary control window 600 detached from the operating system task bar 110, in which four chats are active. Each graphical subdivision (referred to herein as “slots” 605-620) in control window 600 represents an open chat. This exemplary embodiment illustrates that only one detached control window 600 is needed, instead of multiple minimized chat windows in task bar 110, as seen in FIGS. 1 and 2. Control window 600 also may be minimized, as seen in FIG. 6B. In one embodiment, chat window manager 500 displays the number of chats that are open and how many are active if control window 600 is minimized. This feature also is illustrated in FIG. 6B, represented by the text “1 of 4 chatting” in minimized control window 600. A user may temporarily or permanently restore minimized control window 600 to its maximized state by clicking it or by hovering a pointer over it for a given time. Alternatively or additionally, chat window manager 500 may restore minimized control window 600 if a new message is received or a new chat session opened.

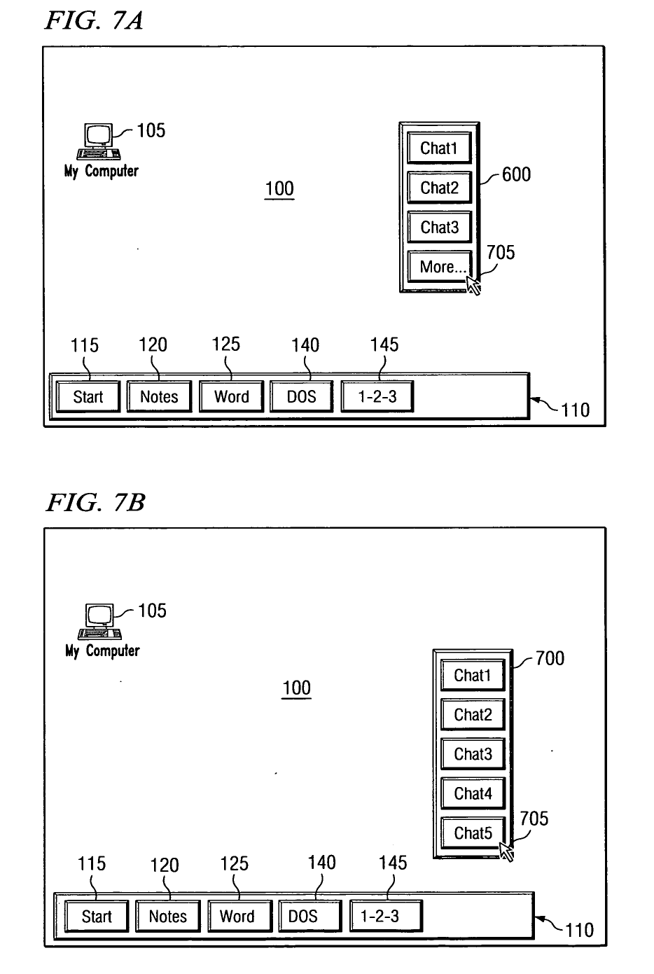

Chat window manager 500 also can compress chat information in control window 600 if the size of control window is insufficient to display all information. In FIG. 7A, for example, a fifth chat is active but neither the user nor chat window manager 500 has enlarged the window to accommodate the additional information. As a result, not all information can be displayed. As shown in FIG. 7B, though, chat window manager 500 creates pop-up list 700 of all five chats if a user places a pointer, such as pointer 705, over compressed control window 600. If compressed control window 600 were located along the left or right edge of the display, then pop-up list 700 would be displayed to the right or left of compressed control window 600, respectively. Likewise, pop-up list 700 would be displayed above or below compressed control window 600 if compressed control window 600 were located along the bottom or top edge of the display, respectively.

From open control window 600 or from pop-up list 700, a user can select a particular chat entry to obtain additional information about the particular chat. Various means for selecting an entry are contemplated, but placing a pointer over the entry and hovering for a given time or clicking a button on the pointing device are preferred means. After a user selects a particular chat entry, chat window manager 500 displays descriptive chat data in a separate pop-up window. Alternatively or additionally, a user may select a particular chat entry to have chat window manager 500 open the particular chat in a chat window.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. In a computer having a graphical user interface, including a display and a selection device, a method of managing chat windows in an instant messaging program, the method comprising:
receiving an input signal from the selection device indicating the selection and movement of a minimized chat window in a task bar; and
responsive to receiving the input signal, detaching the minimized chat window from the task bar and moving the minimized chat window to a position on the display indicated by the input signal.

2. The method of claim 1 wherein the minimized chat window is a compressed chat window representing two or more chat windows.

3. The method of claim 2 further comprising:
receiving a second input signal from the selection device indicating the selection of the detached minimized chat window; and
responsive to receiving the second input signal, displaying on the display a pop-up list of the chat windows.

4. The method of claim 3 further comprising:
receiving a third input signal from the selection device indicating a pointer is positioned over the pop-up list of the chat windows; and
responsive to receiving the third input signal, determining which chat window in the list the pointer is positioned over and displaying descriptive data about the chat window that the pointer is positioned over.

5. A computer-readable memory having a computer program for performing a method of
managing chat windows in an instant messaging program, the method comprising:
receiving an input signal from the selection device indicating the selection and movement of a minimized chat window in a task bar; and
responsive to receiving the input signal, detaching the minimized chat window from the task bar and moving the minimized chat window to a position on the display indicated by the input signal.

6. The computer-readable memory of claim 5 wherein the minimized chat window is a compressed chat window representing two or more chat windows.

7. The computer-readable memory of claim 6 wherein the method further comprises:
receiving a second input signal from the selection device indicating the selection of the detached minimized chat window; and
responsive to receiving the second input signal, displaying on the display a pop-up list of the chat windows.

8. The computer-readable memory of claim 7 wherein the method further comprises:
receiving a third input signal from the selection device indicating a pointer is positioned over the pop-up list of the chat windows; and
responsive to receiving the third input signal, determining which chat window in the list the pointer is positioned over and displaying descriptive data about the chat window that the pointer is positioned over.

9. A computer comprising:
a processor;
a memory coupled to the processor;
a display device coupled to the processor;
a selection device coupled to the processor; and
a computer program in the memory, the computer program comprising instructions for causing the processor to
receive an input signal from the selection device indicating the selection and movement of a minimized chat window in a task bar; and
responsive to receiving the input signal, detach the minimized chat window from the task bar and move the minimized chat window to a position on the display indicated by the input signal.

10. The computer of claim 9 wherein the minimized chat window is a compressed chat window representing two or more chat windows.

11. The computer of claim 10 wherein the computer program further comprises instructions for causing the processor to:
receive a second input signal from the selection device indicating the selection of the detached minimized chat window; and
responsive to receiving the second input signal, display on the display a pop-up list of the chat windows.

12. The computer of claim 11 wherein the computer program further comprises instructions for causing the processor to:
receive a third input signal from the selection device indicating a pointer is positioned over the pop-up list of the chat windows; and
responsive to receiving the third input signal, determine which chat window in the list the pointer is positioned over and display descriptive data about the chat window that the pointer is positioned over.
